(19) United States
(12) Patent Application Publication
(10) Pub. No.: US 2022/0166967 A1
(43) Pub. Date: May 26, 2022

(54) INTRA CODING MODE SIGNALLING IN A VIDEO CODEC

(71) Applicant: British Broadcasting Corporation, London (GB)

(72) Inventors: SAVERIO BLASI, LONDON (GB); ANDRE SEIXAS DIAS, LONDON (GB); GOSALA KULUPANA, LONDON (GB)

(21) Appl. No.: 17/436,427

(22) PCT Filed: Dec. 23, 2019
(86) PCT No.: PCT/GB2019/053697

§ 371 Date: Sep. 3, 2021

(30) Foreign Application Priority Data
Mar. 8, 2019 (GB) 1903170.7

(51) Int. Cl. H04N 19/105; H04N 19/11; H04N 19/159; H04N 19/176

(52) U.S. Cl. CPC H04N 19/105; H04N 19/176; H04N 19/159; H04N 19/11

(57) ABSTRACT

Signalling of an intra-prediction mode is achieved by indicating whether or not to compile an MPM list, on the basis of a test as to the expectation that the MPM list will bear useful information. If an MPM is not convenient, then the mode is directly signalled. If the MPM list is to be constructed, then the mode can be signallad as a member of the MPM list or, if not a member, can be signalled directly or as a member of a mode list comprising all modes not on the MPM list.

### FIELD

The present disclosure relates to signalling in a video codec. More specifically, it relates to signalling intra-prediction modes in a video codec.

### BACKGROUND

Intra-prediction comprises performing a prediction in a block of samples in a video frame by means of using reference samples extracted from within the same frame. Such prediction can be obtained by means of different techniques, referred to as “modes” in conventional codec architectures.

In the proposed VVC (Versatile Video Coding) technology being developed by the Joint Video Exploration Team (JVET), it is intended to define a plurality of possible intra-prediction modes. One of these modes can thus be used for intra-prediction, and the particular selected mode can be signalled in the bitstream, or otherwise determined at the decoder.

In working draft 4 of the VVC specification, it is proposed to define 67 intra-prediction modes as being available for use in decoding. These modes occupy three main categories: Planar, DC and angular. The DC and Planar modes perform a prediction by computing the average, or a position dependent weighted average, respectively, of the reference samples. On the other hand, angular (or directional) intra-prediction modes perform a prediction by extrapolating the reference samples along a direction of prediction.

Each mode in the current draft specifications of the VVC standard is identified by a unique index, ranging from 0 (which corresponds to the Planar mode), 1 (the DC mode) and then 2 to 66 (which refer to the various angular intra-prediction modes). Intra-prediction modes are signalled by computing a list of “Most Probable Modes” (MPM). The MPM list is computed based on information extracted from neighbouring blocks, and contains a list of modes that are most likely to be used in a block. For instance, for a current block under consideration, if the blocks to the top and left of the current block make use of “vertical” angular modes (i.e. modes that perform angular prediction extrapolating the reference samples along a vertical direction of prediction), then the MPM list will contain mostly vertical angular prediction modes, based on the assumption that neighbouring blocks are highly correlated with each other. The way of computing the MPM list should be known by decoder and encoder.

When signalling a mode, the bitstream contains a binary flag which signals whether the mode is in the MPM list or not.

If this binary flag indicates that the mode is in the MPM list, then a mechanism is implemented to signal the index to extract the correct element in the list. Without loss of generality, it is worth mentioning as a matter of exemplification that in the current VVC draft specifications, the MPM list is of a fixed length of 6, and the items in the list are indexed in this way:

| Index | Binarization |
|---|---|
| 0 | 0 |
| 1 | 10 |
| 2 | 110 |
| 3 | 1110 |
| 4 | 11110 |
| 5 | 11111 |

Other sizes of the MPM list may be considered, as well as other mechanisms to identify the correct element to use in the list.

If, on the other hand, the binary flag indicates that the mode is NOT in the MPM list, then a mechanism is implemented to signal the index of the intra-prediction mode. This mechanism takes into account the modes that are present in the MPM list. It is assumed that the MPM list is of length M. As the flag indicates that the mode being used is not in the MPM list, that means that M of the possible total modes are beyond consideration. If the total number of available modes is N, there are (N-M) possible remaining intra-prediction modes. As an example, assuming there are a total of 67 available modes and the MPM list is of length 6 then, if the mode is not in the MPM list, it can be one of 61 possible remaining intra-prediction modes (the total available 67 minus the 6 in the MPM list).

These remaining modes are assigned a “remaining intra-mode index” from 0 to 61, and this index is then encoded in the bitstream using a specific binarization. The actual mechanism to assign a “remaining intra-mode index” to a given intra-prediction mode, as well as the actual binarization used to encode the “remaining intra-mode index” are outside of the scope of this disclosure. Any method can be used without loss of generality.

Several proposals, including proposals JVET-M0528 and JVET-M0210, have been presented to JVET, to change the way intra-prediction modes are signalled, with regard to the arrangements set out in the draft VVC standard. Specifically, among other changes, the following changes have also been proposed.

When signalling a mode, a first binary flag is first signalled in the bitstream to identify whether the mode is “directional” or “non-directional”. Angular modes may be considered “directional”, whereas Planar and DC modes may be considered “non-directional”. Other ways of partitioning the modes may be considered.

If this first binary flag indicates that the mode is non-directional, then a second binary flag is signalled to identify whether the mode is Planar or DC.

If, on the other hand, the first binary flag indicates that the mode is directional, then a third binary flag is signalled to identify whether the mode is in the MPM list or not.

If the third binary flag indicates that the mode is in the MPM list, then a mechanism is implemented to signal the index to extract the correct element in the list. This could be the same mechanism as previously mentioned.

If the third binary flag indicates that the mode is not in the MPM list, then a mechanism is implemented to signal the index of the “remaining intra-mode index”, meaning the intra-prediction mode taking into account the modes in the MPM list.

In these above proposals, the computation of the MPM list is modified so that only directional modes can be included in the list.

### DESCRIPTION OF DRAWINGS

FIG. 1 is a schematic representation of a communications network in accordance with an embodiment;

FIG. 2 is a schematic representation of an emitter of the communications network of FIG. 1;

FIG. 3 is a diagram illustrating an encoder implemented on the emitter of FIG. 2;

FIG. 4 is a flow diagram of a prediction process performed at a prediction module of the encoder of FIG. 3;

FIG. 5 is a schematic representation of a receiver of the communications network of FIG. 1;

FIG. 6 is a diagram illustrating a decoder implemented on the receiver of FIG. 4; and

FIG. 7 is a flow diagram of a prediction process performed at a prediction module of the decoder of FIG. 6.

### DESCRIPTION OF EMBODIMENTS

Aspects of the present disclosure may correspond with the subject matter of the appended claims.

In general terms, signalling of an intra-prediction mode is achieved by determining whether or not to compile an MPM list, on the basis of a test as to the expectation that the MPM list will bear useful information. If an MPM list is not convenient, then the mode is directly signalled. If the MPM list is to be constructed, then the mode can be signalled as a member of the MPM list or, if not a member, can be signalled directly or as a member of a mode list comprising all modes not on the MPM list.

In general terms, parsing of an intra-prediction mode is achieved by determining whether or not the mode may be part of an MPM list, on the basis of a test as to the expectation that the MPM list will bear useful information. If the mode is determined to be not part of an MPM list, then the mode is directly parsed. Otherwise, signalling is parsed to determine whether the mode is a member of an MPM list or not. If the mode is a member of the MPM list, the MPM list is to be constructed and the mode is signalled as a member of the MPM list, otherwise, if not a member, the mode is parsed directly or it is parsed on the basis of the modes in the MPM list.

Aspects of the disclosure can be determined from the claims appended hereto.

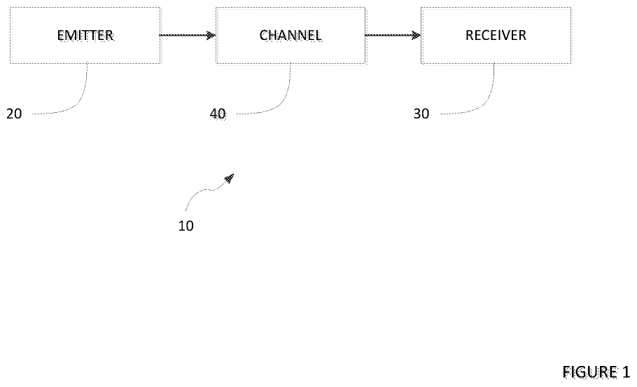

As illustrated in FIG. 1, an arrangement is illustrated comprising a schematic video communication network 10, in which an emitter 20 and a receiver 30 are in communication via a communications channel 40. In practice, the communications channel 40 may comprise a satellite communications channel, a cable network, a ground-based radio broadcast network, a POTS-implemented communications channel, such as used for provision of internet services to domestic and small business premises, fibre optic communications systems, or a combination of any of the above and any other conceivable communications medium.

Furthermore, the disclosure also extends to communication, by physical transfer, of a storage medium on which is stored a machine readable record of an encoded bitstream, for passage to a suitably configured receiver capable of reading the medium and obtaining the bitstream therefrom. An example of this is the provision of a digital versatile disk (DVD) or equivalent. The following description focuses on signal transmission, such as by electronic or electromagnetic signal carrier, but should not be read as excluding the aforementioned approach involving storage media.

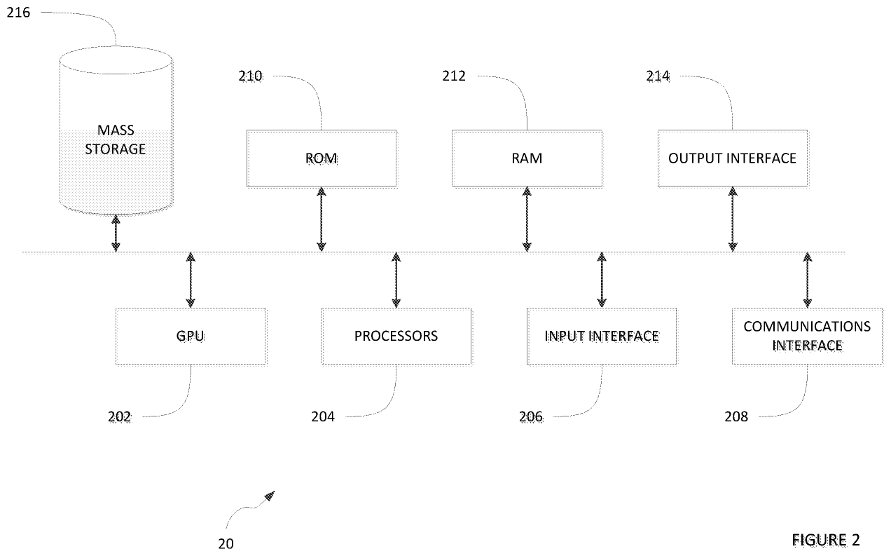

As shown in FIG. 2, the emitter 20 is a computer apparatus, in structure and function. It may share, with general purpose computer apparatus, certain features, but some features may be implementation specific, given the specialised function for which the emitter 20 is to be put. The reader will understand which features can be of general purpose type, and which may be required to be configured specifically for use in a video emitter.

The emitter 20 thus comprises a graphics processing unit (GPU) 202 configured for specific use in processing graphics and similar operations. The emitter 20 also comprises one or more other processors 204, either generally provisioned, or configured for other purposes such as mathematical operations, audio processing, managing a communications channel, and so on.

An input interface 206 provides a facility for receipt of user input actions. Such user input actions could, for instance, be caused by user interaction with a specific input unit including one or more control buttons and/or switches, a keyboard, a mouse or other pointing device, a speech recognition unit enabled to receive and process speech into control commands, a signal processor configured to receive and control processes from another device such as a tablet or smartphone, or a remote-control receiver. This list will be appreciated to be non-exhaustive and other forms of input, whether user initiated or automated, could be envisaged by the reader.

Likewise, an output interface 214 is operable to provide a facility for output of signals to a user or another device. Such output could include a display signal for driving a local video display unit (VDU) or any other device.

A communications interface 208 implements a communications channel, whether broadcast or end-to-end, with one or more recipients of signals. In the context of the present embodiment, the communications interface is configured to cause emission of a signal bearing a bitstream defining a video signal, encoded by the emitter 20.

The processors 204, and specifically for the benefit of the present disclosure, the GPU 202, are operable to execute computer programs, in operation of the encoder. In doing this, recourse is made to data storage facilities provided by a mass storage device 208 which is implemented to provide large-scale data storage albeit on a relatively slow access basis, and will store, in practice, computer programs and, in the current context, video presentation data, in preparation for execution of an encoding process.

A Read Only Memory (ROM) 210 is preconfigured with executable programs designed to provide the core of the functionality of the emitter 20, and a Random Access Memory 212 is provided for rapid access and storage of data and program instructions in the pursuit of execution of a computer program.

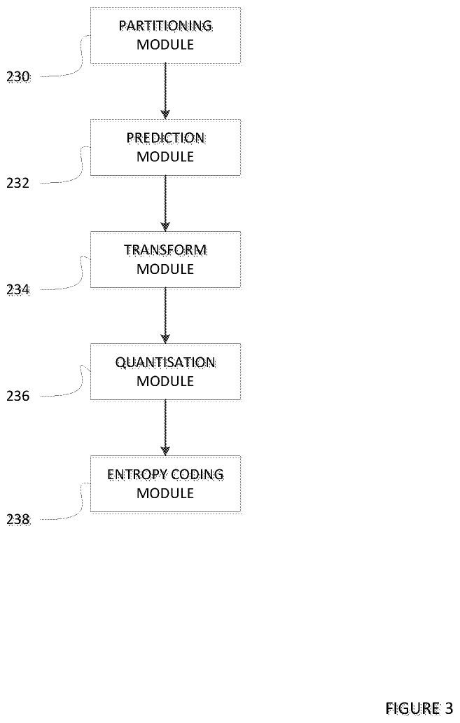

The function of the emitter 20 will now be described, with reference to FIG. 3. FIG. 3 shows a processing pipeline performed by an encoder implemented on the emitter 20 by means of executable instructions, on a datafile representing a video presentation comprising a plurality of frames for sequential display as a sequence of pictures.

The datafile may also comprise audio playback information, to accompany the video presentation, and further supplementary information such as electronic programme guide information, subtitling, or metadata to enable cataloguing of the presentation. The processing of these aspects of the datafile are not relevant to the present disclosure.

Referring to FIG. 3, the current picture or frame in a sequence of pictures is passed to a partitioning module 230 where it is partitioned into rectangular blocks of a given size for processing by the encoder. This processing may be sequential or parallel. The approach may depend on the processing capabilities of the specific implementation.

Each block is then input to a prediction module 232, which seeks to discard temporal and spatial redundancies present in the sequence and obtain a prediction signal using previously coded content. Information enabling computation of such a prediction is encoded in the bitstream. This information should comprise sufficient information to enable computation, including the possibility of inference at the receiver of other information necessary to complete the prediction.

The prediction signal is subtracted from the original signal to obtain a residual signal. This is then input to a transform module 234, which attempts to further reduce spatial redundancies within a block by using a more suitable representation of the data. The reader will note that, in some embodiments, domain transformation may be an optional stage and may be dispensed with entirely. Employment of domain transformation, or otherwise, may be signalled in the bitstream.

The resulting signal is then typically quantised by quantisation module 236, and finally the resulting data formed of the coefficients and the information necessary to compute the prediction for the current block is input to an entropy coding module 238 makes use of statistical redundancy to represent the signal in a compact form by means of short binary codes. Again, the reader will note that entropy coding may, in some embodiments, be an optional feature and may be dispensed with altogether in certain cases. The employment of entropy coding may be signalled in the bitstream, together with information to enable decoding, such as an index to a mode of entropy coding (for example, Huffman coding) and/or a code book.

By repeated action of the encoding facility of the emitter 20, a bitstream of block information elements can be constructed for transmission to a receiver or a plurality of receivers, as the case may be. The bitstream may also bear information elements which apply across a plurality of block information elements and are thus held in bitstream syntax independent of block information elements. Examples of such information elements include configuration options, parameters applicable to a sequence of frames, and parameters relating to the video presentation as a whole.

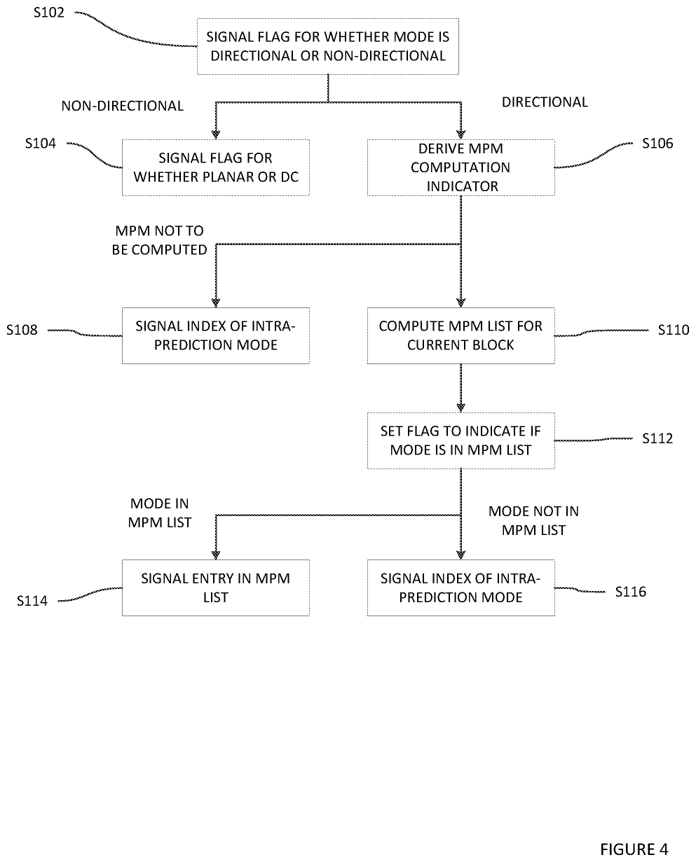

The prediction module 232 will now be described in further detail, with reference to FIG. 4. As will be understood, this is but an example, and other approaches, within the scope of the present disclosure and the appended claims, could be contemplated.

The following process is performed on each block in a frame.

The prediction module 232 is configured to determine, for a given block partitioned from a frame, whether intra-prediction is to be employed and, if so, which of a plurality of predetermined intra-prediction modes is to be used. The prediction module then applies the selected mode of intra-prediction, if applicable, and then determines a prediction, on the basis of which residuals can then be generated as previously noted. The prediction employed is signalled in the bitstream, for receipt and interpretation by a suitably configured decoder. The encoder will signal on the bitstream information to enable a decoder to determine which mode has been used, in a manner which will now be described with reference to FIG. 4.

FIG. 4 shows a decision tree which is processed by the encoder in determining the information to be inserted into the bitstream to signal the intra-prediction mode employed in encoding a particular block.

In general terms, a principle of the described embodiment is that it seeks to avoid using the information in the MPM list if the opportunity arises to do so, for instance in the case where no directional modes can be extracted from the neighbouring blocks, or in the case where the current mode is not in the MPM list.

Thus, when signalling a mode, a binary flag “mode_directional” is first set in step S102 to identify whether the mode is “directional” or “non-directional”. Angular modes are considered “directional”, whereas Planar and DC modes are considered “non-directional”.

Then, if the mode_directional flag signals that the mode is non-directional, then in step S104 another binary flag “mode_nd_PorDC” is set to identify whether the mode is Planar or DC.

On the other hand, if the mode_directional flag signals that the mode is directional, then in step S106 a binary variable is derived for a given block, referred to as “no_mpm_computation”. This is set to TRUE in the case wherein it is unlikely that an MPM list could be computed which contains useful information. Several mechanisms could be employed to derive the “no_mpm_computation” variable. As an example, the variable “no_mpm_computation” is set to FALSE in case there is at least one directional mode available extracted from neighbouring blocks, and it is set to TRUE otherwise.

If “no_mpm_computation” is set to TRUE for a directional mode, then a mechanism is implemented to signal the index of the intra-prediction mode, taking into account that the mode is directional and therefore it cannot be any of the non-directional modes, for instance Planar or DC. This index is generated in step S108 as illustrated in FIG. 4. For example, in the specific context of the draft VVC standard, in which 67 possible available modes are defined, and assuming that the non-directional modes are Planar and DC, this leaves 65 possible directional modes available for use. Thus, a mode index from 0 to 64 is signalled in the bitstream to indicate which of these modes is used. Other mechanisms could be used to signal this mode.

The reader will appreciate that, if the intra-prediction mode is directly signalled, as in step S108, no information from the MPM list is needed. Thus, this particular part of the process avoids the computation of an MPM list when the “no_mpm_computation” variable is set to TRUE, for instance when no directional mode can be extracted from neighbouring blocks.

If, on the other hand, “no_mpm_computation” is set to FALSE, then in step S110 the MPM list is computed for the current block. A binary flag “mode_in_list” is then signalled in step S112 to identify whether the intra-prediction mode employed on the current block is in the MPM list or not.

If the current intra-prediction mode is in the MPM list, a mechanism is used in step S114 to signal the index of the correct element in the MPM list.

Conversely, if the current intra-prediction mode is not one of the modes in the MPM list, then a mechanism is used in step S116 to signal the index of the intra-prediction mode.

In one specific case of the described embodiment, in the event that the intra-prediction mode is not in the MPM list, the encoder signals the intra-prediction mode in a manner which avoids the need for a decoder to compute the MPM list. In this case, the encoder signals the index of the intra-prediction mode, taking into account that the mode is directional and therefore it cannot be any of the non-directional modes, for instance Planar or DC.

So, in the specific context of the draft VVC standard, in which 67 possible available modes are defined, and assuming that the non-directional modes are Planar and DC, this leaves 65 possible directional modes available for use. Thus, a mode index from 0 to 64 is signalled in the bitstream to indicate which of these modes is used. Other mechanisms could be used to signal this mode.

In the above case of the described embodiment, if the intra-prediction mode is not in the MPM list, no information from the MPM list may be needed when signalling it.

Thus, this particular part of the process avoids using information in the MPM list when the mode is not in the MPM list. Also, by signalling the mode without reference to its non-membership of the MPM list, this advantageously avoids the need for a decoder to carry out a corresponding computation of the MPM list to determine which of the non-member modes is being indexed.

In an alternative approach, a specific case of the described embodiment could be implemented in which a mechanism is employed for signalling the mode that has been used, wherein the mechanism does require information from the MPM list. In this case, the intra-prediction mode is signalled using an index to a list of available directional modes, excluding the modes on the MPM list. This “remaining intra-mode index” is thus assigned in a way that depends on the information present in the MPM list.

For example, in the specific context of the draft VVC standard, in which 67 possible available modes are defined, and assuming that the non-directional modes are Planar and DC, and assuming that there are 6 modes in the MPM list, 59 possible directional modes remain available for use. Thus, a mode index from 0 to 58 is signalled in the bitstream to indicate which of these modes is used.

So, the embodiment as described above, and with reference to the specific cases detailed above, can lead to a number of performance outcomes.

A case is considered in which the utilised intra-prediction mode is determined as directional, but “no_mpm_computation” is set to true, and thence the encoding of the remaining intra-prediction mode is performed without using the information in the MPM list. This scenario arises when there is no prospect of construction of a meaningful MPM list, for instance when the relevant neighbours of the current block are encoded using non-directional intra-prediction modes. So, in the example of the draft VVC technology, in which there are 67 possible modes, then 65 of these modes are directional and thus potential candidates. An index between 0 and 64 is then signalled in the bitstream using a pre-defined mechanism.

When using this manner of signalling, the decoder does not need to compute the MPM list if the “no_mpm_computation” is derived to be true.

In another scenario wherein the utilised mode is directional, and it is not one identified in the MPM list, the encoding of the remaining intra-prediction mode is also performed without using the information in the MPM list. In the specific case of the draft VVC technology, in which there are 67 possible available modes, there would be 59 possible directional modes available in this situation: the 65 possible directional modes, minus the 6 directional modes in the MPM list. However, in pursuit of avoiding using the information in the MPM list, a mechanism is deployed that signals this mode without taking into account the information in the MPM list. An index between 0 and 64 is then signalled in the bitstream using a pre-defined mechanism.

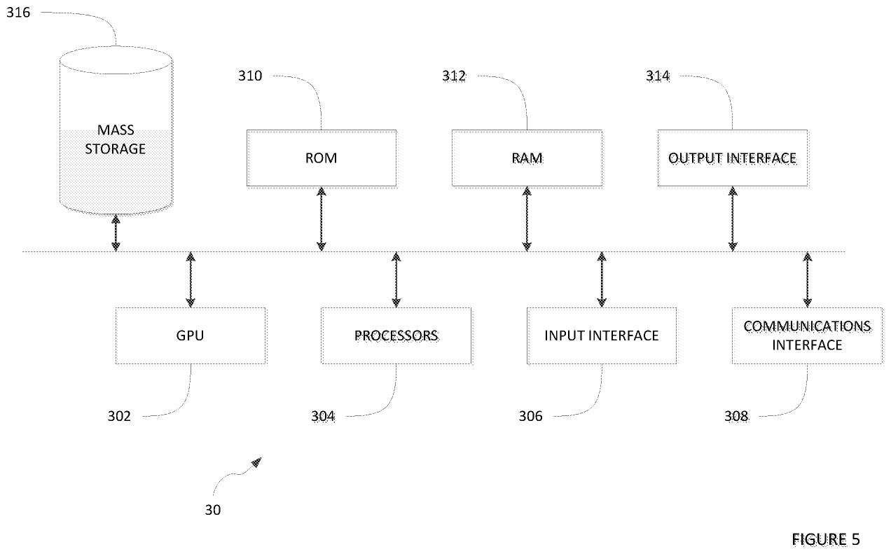

The structural architecture of the receiver is illustrated in FIG. 5. It has the elements of being a computer implemented apparatus. The receiver 30 thus comprises a graphics processing unit 302 configured for specific use in processing graphics and similar operations. The receiver 30 also comprises one or more other processors 304, either generally provisioned, or configured for other purposes such as mathematical operations, audio processing, managing a communications channel, and so on.

As the reader will recognise, the receiver 30 may be implemented in the form of a set-top box, a hand held personal electronic device, a personal computer, or any other device suitable for the playback of video presentations.

An input interface 306 provides a facility for receipt of user input actions. Such user input actions could, for instance, be caused by user interaction with a specific input unit including one or more control buttons and/or switches, a keyboard, a mouse or other pointing device, a speech recognition unit enabled to receive and process speech into control commands, a signal processor configured to receive and control processes from another device such as a tablet or smartphone, or a remote-control receiver. This list will be appreciated to be non-exhaustive and other forms of input, whether user initiated or automated, could be envisaged by the reader.

Likewise, an output interface 314 is operable to provide a facility for output of signals to a user or another device. Such output could include a television signal, in suitable format, for driving a local television device.

A communications interface 308 implements a communications channel, whether broadcast or end-to-end, with one or more recipients of signals. In the context of the present embodiment, the communications interface is configured to cause emission of a signal bearing a bitstream defining a video signal, encoded by the receiver 30.

The processors 304, and specifically for the benefit of the present disclosure, the GPU 302, are operable to execute computer programs, in operation of the receiver. In doing this, recourse is made to data storage facilities provided by a mass storage device 308 which is implemented to provide large-scale data storage albeit on a relatively slow access basis, and will store, in practice, computer programs and, in the current context, video presentation data, resulting from execution of an receiving process.

A Read Only Memory (ROM) 310 is preconfigured with executable programs designed to provide the core of the functionality of the receiver 30, and a Random Access Memory 312 is provided for rapid access and storage of data and program instructions in the pursuit of execution of a computer program.

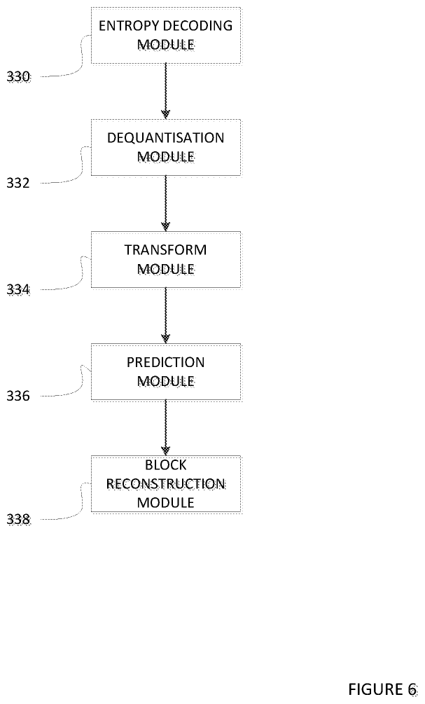

The function of the receiver 30 will now be described, with reference to FIG. 6. FIG. 6 shows a processing pipeline performed by a decoder implemented on the receiver 20 by means of executable instructions, on a bitstream received at the receiver 30 comprising structured information from which a video presentation can be derived, comprising a reconstruction of the frames encoded by the encoder functionality of the emitter 20.

The decoding process illustrated in FIG. 6 aims to reverse the process performed at the encoder. The reader will appreciate that this does not imply that the decoding process is an exact inverse of the encoding process.

A received bit stream comprises a succession of encoded information elements, each element being related to a block. A block information element is decoded in an entropy decoding module 330 to obtain a block of coefficients and the information necessary to compute the prediction for the current block. The block of coefficients is typically de-quantised in dequantisation module 332 and typically inverse transformed to the spatial domain by transform module 334.

As noted above, the reader will recognise that entropy decoding, dequantisation and inverse transformation would only need to be employed at the receiver if entropy encoding, quantisation and transformation, respectively, had been employed at the emitter.

A prediction signal is generated as before, from previously decoded samples from current or previous frames and using the information decoded from the bit stream, by prediction module 336. A reconstruction of the original picture block is then derived from the decoded residual signal and the calculated prediction block in the reconstruction block 338. The prediction module 336 is responsive to information, on the bitstream, signalling the use of intra-prediction and, if such information is present, reading from the bitstream information which enables the decoder to determine which intra-prediction mode has been employed and thus which prediction technique should be employed in reconstruction of a block information sample.

By repeated action of the decoding functionality on successively received block information elements, picture blocks can be reconstructed into frames which can then be assembled to produce a video presentation for playback.

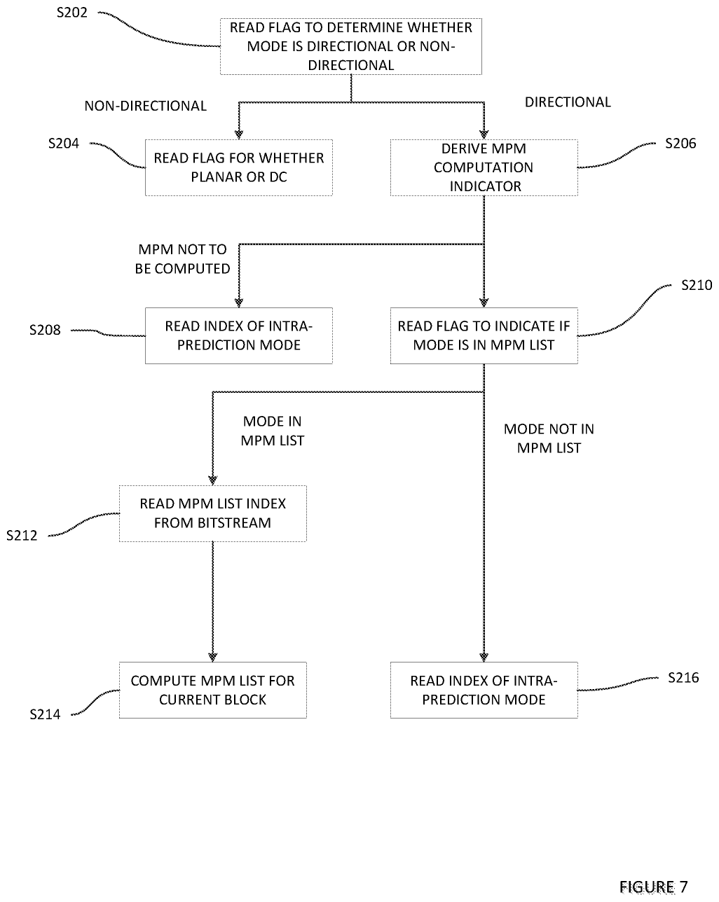

An exemplary decoder algorithm, complementing the encoder algorithm described earlier, is illustrated in FIG. 7.

As noted previously, the decoder functionality of the receiver 30 extracts from the bitstream a succession of block information elements, as encoded by the encoder facility of the emitter 20, defining block information and accompanying configuration information.

In general terms, the decoder avails itself of information from prior predictions, in constructing a prediction for a present block. In doing so, the decoder may combine the knowledge from inter-prediction, i.e. from a prior frame, and intra-prediction, i.e.

from another block in the same frame. The present embodiment is concerned with signalling of intra-prediction and, specifically, with signalling which particular mode, of a plurality of pre-defined intra-prediction modes, has been employed in encoding a particular block.

So, in a first stage, in step S202, the decoder reads from the bitstream a binary flag “mode_directional” on the basis of which the decoder can deduce whether the mode is “directional” or “non-directional”.

Then, if the mode_directional flag signals that the mode is non-directional, then in step S204 another binary flag “mode_nd_PorDC” is read from the bitstream, on the basis of which the decoder determines whether the mode is Planar or DC. Based on this outcome, the decoder decodes the block.

On the other hand, if the mode_directional flag signals that the mode is directional, then, in step S206, a variable “no_mpm_computation” is derived. This is Boolean, hence can be TRUE or FALSE. This variable may be inferred from information that is already available extracted from neighbouring blocks. As an example, in case at least one neighbouring block, for instance the mode directly above or directly on the left of the current block, was intra-predicted using a “directional” mode, then the variable “no_mpm_computation” is set to FALSE. Else, if no neighbouring block is intra-predicted using a “directional” mode, then the variable “no_mpm_computation” is set to TRUE. Other processes of setting the “no_mpm_computation” variable may be used, which may also make use of information that is directly signalled in the bitstream.

If “no_mpm_computation” is set to TRUE, then in step S208 an index is read from the bitstream on the basis of which the decoder can select an indicated one of the specified directional intra-prediction modes. For example, in the specific context of the draft VVC standard, in which 67 possible available modes are defined, two of these modes are Planar and DC, leaving 65 possible directional modes available for use. Thus, a mode index from 0 to 64 is signalled in the bitstream to indicate which of these modes is used. The decoder has a table, corresponding with a similar table at the encoder, in which the possible directional modes are matched with indices. Other techniques to extract this mode from the bitstream may be considered. These techniques may not require the computation of an MPM list.

If, on the other hand, “no_mpm_computation” is set to false, then in step S210, binary flag “mode_in_list” is read from the bitstream. The decoder is configured to respond to this flag to determine whether the intra-prediction mode employed on the current block is in the MPM list or not. Note that, in FIG. 7, this is not labelled as “MPM to be computed” (i.e. the opposite of “MPM not to be computed”) as it is not necessarily the case that, even in this branch of the process, the MPM list needs to be computed, as will be explained.

If “mode_in_list” indicates that the intra-prediction mode to be employed on the current block is in the MPM list, then in step S212 an index is read from the bitstream by the decoder, the index indicating an element in the MPM list. In step S214 the MPM list is computed for the current block. The encoder and decoder are preconfigured with the same rules for construction of the MPM list, so that the same MPM list will be constructed in the pursuit of encoding at the encoder and decoding at the decoder, without a need to transmit an MPM list along the communication channel. The index is used to extract the correct element from the MPM list. The indicated intra-prediction mode is then employed by the decoder to decode the block.

On the other hand, if “mode_in_list” indicates that the intra-prediction mode to be employed on the current block is not one of the modes in the MPM list, then in step S216 the decoder constructs a list of remaining intra-prediction modes. The same set of rules for constructing this list are employed at the decoder as in pursuit of step S116 at the encoder. This process may be performed without requiring computation of an MPM list. In this case, the list of remaining intra-prediction modes may contain modes that would be present in the MPM list. This simplifies the decoder process, as no MPM list computation is required to decode this mode.

In an alternative arrangement of the embodiment, it is possible to signal the mode, not in the MPM list, with reference to the MPM list. In this case, the index will point to a list of modes compiled to exclude those modes on the MPM list. For this version of the process, decoding may be performed on computation of an MPM list. In this second case, the list of remaining intra-prediction modes, to which the index will refer, will not contain modes that are in the MPM list.

The same set of rules for constructing this list are employed at the decoder as in pursuit of step S116 at the encoder. This ensures that indexes sent by the encoder lead to consistent look-up at the decoder.

Then, an index is read from the bitstream which corresponds to an entry on that list, and thus identifying a particular one of the intra-prediction modes. This identified intra-prediction mode is then employed by the decoder to decode the block.

As the reader will see, on the decoder side, embodiments described herein can simplify the decoding process beyond the arrangements proposed in the current VVC draft specifications and submitted proposals for amendment thereof.

Thus, in summary, when signalling an intra-prediction mode, a binary flag is first used to identify whether such mode is in the MPM list or not. If that binary flag indicates that the mode is in the MPM list, then a mechanism is implemented to signal the index to extract the correct element in the list. On the other hand, if the binary flag indicates that the mode is NOT in the MPM list, then a mechanism is implemented to signal the index of the intra-prediction mode. In this case, the process is performed without taking into account the membership of the MPM list. As an example, there are 67 possible intra-prediction modes. An index ranging from 0 to 65 is then encoded in the bitstream using a specific binarization. At the decoder side, no MPM derivation is needed in this case.

It will be observed by the reader that, in certain embodiments, the decoder can derive whether a given mode is non-angular or angular without any parsing dependencies, meaning, this information is known to the decoder at parsing time. That is, the information conveyed on the bitstream may be structured so that the decision as to whether the specified mode is non-angular (and thus quickly identifiable as planar or DC) can be made at the outset, rather than after further deductions and construction of an MPM list, which may be costly in terms of computation time.

Further, it will be observed by the reader that, in certain embodiments, if it is established that non-directional modes are not allowed to be specified in the MPM list, and given that the construction of the MPM list depends on the intra-prediction modes extracted from neighbouring blocks, then the construction of the MPM list may be sub-optimal in the case that no directional modes can be extracted from neighbouring blocks, as no information on the directionality of intra-prediction can be extracted from such modes.

This observation can be better exemplified as follows. In an example implementation, the encoder needs to encode a given directional mode for a given block. In this example, the block above the current block (which can be called the “top block”) was encoded making use of the Planar intra-prediction mode; the block to the left of the current block (which can be called the “left block”) was encoded making use of the DC intra-prediction mode.

In the existing draft VVC specification, the MPM list for the current block would contain the Planar and DC mode in the first positions in the list, as these are the most likely modes to be needed in the current block. However, the proposals identified in the introductory part of this disclosure modify the rules for intra-prediction mode signalling, such that only directional modes can be placed in the MPM list. Thus, the most likely modes would not be present in the MPM list for the block the subject of this example. This means the MPM list is constructed without any reference to what modes are actually used in the top block and the left block. That said, in the presently disclosed embodiments, if the current block is actually encoded using a non-directional mode, this is signalled before any consideration of constructing an MPM list, which eliminates this computational overhead. Further, if the current block is encoded using a directional mode of intra-prediction, despite the non-directional intra-prediction modes used in the neighbouring block, it is computationally more efficient not to include the non-directional modes in the MPM block which would be a needless overhead.

Further, it will be observed by the reader that, in certain embodiments, the decoder can derive a mode that is not in the MPM list without any consideration of constructing an MPM list, which eliminates this computational overhead.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. An encoder operable to encode a block of a frame of video onto a bitstream, the encoder comprising:
an intra-prediction module operable to encode the block with reference to one or more other blocks in the frame in accordance with a selected one of a plurality of intra-prediction modes, the plurality of intra-prediction modes comprising a plurality of directional modes;
a list construction module operable to construct a most probable modes, MPM, list, on the basis of prior encoding of other blocks of the frame, of most probable modes to be employed in encoding the present block, with respect to a predetermined list construction rule;
wherein the intra-prediction module is operable to apply an advantage test to determine whether construction of an MPM list will be operationally advantageous and, if not, to place mode-identification information on the bitstream to enable identification of the selected mode from the plurality of directional modes;
otherwise to cause the list construction module to construct the MPM list for the block and:
if the selected mode is on the MPM list, to place mode-identification information on the bitstream to enable identification of the selected mode from the MPM list;
otherwise to place mode-identification information on the bitstream to enable identification of the selected mode from the plurality of directional modes.

2. An encoder in accordance with claim 1 wherein the advantage test comprises considering information extracted from other blocks of the frame.

3. An encoder in accordance with claim 2 wherein the advantage test comprises considering modes employed in encoding other blocks of the frame.

4-11. (canceled)

12. An encoder operable to encode a block of a frame of video onto a bitstream, the encoder comprising:
an intra-prediction module operable to encode the block with reference to one or more other blocks in the frame in accordance with a selected one of a plurality of intra-prediction modes;
a list construction module operable to construct a most probable modes, MPM, list, on the basis of prior encoding of other blocks of the frame, of most probable modes to be employed in encoding the present block, with respect to a predetermined list construction rule;
wherein the intra-prediction module is operable to cause the list construction module to construct the MPM list for the block and:
if the selected mode is on the MPM list, to place mode-identification information on the bitstream to enable identification of the selected mode from the MPM list;
otherwise to place mode-identification information on the bitstream to enable identification of the selected mode as a member of a mode list comprising all of the plurality of modes.

13. (canceled)

14. (canceled)

15. A method of encoding a block of a frame of video onto a bitstream, the method comprising:
encoding the block with reference to one or more other blocks in the frame in accordance with a selected one of a plurality of intra-prediction modes, the plurality of intra-prediction modes comprising a plurality of directional modes;
defining a list construction rule by which a most probable modes, MPM, list, can be constructed, list construction, when performed, being on the basis of prior encoding of other blocks of the frame, an MPM list comprising a list of most probable modes to be employed in encoding the present block;
applying an advantage test to determine whether construction of an MPM list will be operationally advantageous and, if not, placing mode-identification information on the bitstream to enable identification of the selected mode from the plurality of directional modes;
otherwise constructing the MPM list for the block and:
if the selected mode is on the MPM list, placing mode-identification information on the bitstream to enable identification of the selected mode from the MPM list;
otherwise placing mode-identification information on the bitstream to enable identification of the selected mode from the plurality of directional modes.

16. A method in accordance with claim 15 wherein the advantage test comprises considering information extracted from other blocks of the frame.

17. A method in accordance with claim 16 wherein the advantage test comprises considering modes employed in encoding other blocks of the frame.

18-25. (canceled)

26. A method of encoding a block of a frame of video onto a bitstream, the method comprising:
encoding the block with reference to one or more other blocks in the frame in accordance with a selected one of a plurality of intra-prediction modes; defining a list construction rule by which a most probable modes, MPM, list, can be constructed, list construction, when performed, being on the basis of prior encoding of other blocks of the frame, an MPM list comprising a list of most probable modes to be employed in encoding the present block;
constructing the MPM list for the block in accordance with the list construction rule and:
if the selected mode is on the MPM list, placing mode-identification information on the bitstream to enable identification of the selected mode from the MPM list; otherwise placing mode-identification information on the bitstream to enable identification of the selected mode as a member of a mode list comprising all of the plurality of modes.

27-29. (canceled)

30. A decoder configured to receive and decode a bitstream generated by an encoder in accordance with claim 1.

31. A decoder operable to decode an encoded bitstream of a block of a frame of video, the decoder comprising: an intra-prediction decoding module operable to decode the encoded block with reference to one or more other blocks in the frame in accordance with a selected one of a plurality of intra-prediction modes, the plurality of intra-prediction modes comprising a plurality of directional modes;
a list construction module operable to construct a most probable modes, MPM, list, on the basis of prior encoding of other blocks of the frame, of most probable modes to be employed in encoding the present block, with respect to a predetermined list construction rule;
the decoder being operable to apply an advantage test to determine whether construction of an MPM list will be operationally advantageous and, if not, to read from the bitstream a mode index identifying the selected mode from the plurality of directional modes,
otherwise the decoder being operable to read from the bitstream an MPM list membership indicator which indicates to the decoder whether or not the selected mode is in the MPM list such that:
if the MPM list membership indicator indicates that the selected mode is in the MPM list then the decoder is configured to cause the list construction module to construct the MPM list for the block, to read from the bitstream an index to the selected mode in the MPM list and to decode the block in accordance with that mode,
if the MPM list membership indicator indicates that the selected mode is not in the MPM list then the decoder is configured to read information on the bitstream to enable identification of the selected mode from the plurality of directional modes.

32. A decoder in accordance with claim 31 wherein the advantage test comprises considering information extracted from other blocks of the frame.

33. A decoder in accordance with claim 32 wherein the advantage test comprises considering modes employed in encoding other blocks of the frame.

34. (canceled)

35. A decoder operable to decode an encoded bitstream of a block of a frame of video, the decoder comprising:
an intra-prediction decoding module operable to decode the encoded block with reference to one or more other blocks in the frame in accordance with a selected one of a plurality of intra-prediction modes;
a list construction module operable to construct a most probable modes, MPM, list, on the basis of prior encoding of other blocks of the frame, of most probable modes to be employed in encoding the present block, with respect to a predetermined list construction rule;
the decoder being operable to read, from the bitstream, an MPM list membership indicator,
the MPM list membership indicator in one state indicating that the selected mode is a member of the MPM list, the intra-prediction module being responsive to the MPM list indicator in that state to cause the list construction module to construct the MPM list for the block, the decoder being further responsive to read from the bitstream an MPM list index indicating the selected mode on the MPM list;
the MPM list membership indicator in another state indicating that the selected mode is not a member of the MPM list, the decoder being operable to read mode-identification information from the bitstream to enable identification of the selected mode as a member of a mode list comprising all of the plurality of modes.

36. A method of decoding an encoded bitstream of a block of a frame of video, the method comprising:
decoding the encoded block with reference to one or more other blocks in the frame in accordance with a selected one of a plurality of intra-prediction modes, the plurality of intra-prediction modes comprising a plurality of directional modes;
defining a list construction rule for a list construction module operable to construct a most probable modes, MPM, list, on the basis of prior encoding of other blocks of the frame, of most probable modes to be employed in encoding the present block; applying an advantage test to determine whether construction of an MPM list will be operationally advantageous and, if not, reading from the bitstream a mode index identifying the selected mode from the plurality of directional modes;
otherwise reading from the bitstream an MPM list membership indicator which indicates whether or not the selected mode is in the MPM list such that: if the MPM list membership indicator indicates that the selected mode is in the MPM list then constructing the MPM list for the block, reading from the bitstream an index to the selected mode in the MPM list and decoding the block in accordance with that mode,
if the MPM list membership indicator indicates that the selected mode is not in the MPM list then reading information from the bitstream to enable identification of the selected mode from the plurality of directional modes and decoding the block in accordance with that mode.

37. A method in accordance with claim 36 wherein the advantage test comprises considering information extracted from other blocks of the frame.

38. A decoder in accordance with claim 37 wherein the advantage test comprises considering modes employed in encoding other blocks of the frame.

39. (canceled)

40. A method of decoding an encoded bitstream of a block of a frame of video, the method comprising:
decoding the encoded block with reference to one or more other blocks in the frame in accordance with a selected one of a plurality of intra-prediction modes; defining a list construction rule for constructing a most probable modes, MPM, list, on the basis of prior encoding of other blocks of the frame, of most probable modes to be employed in encoding the present block;
the method comprising reading, from the bitstream, an MPM list membership indicator,
the MPM list membership indicator in one state indicating that the selected mode is a member of the MPM list, and, responsive to the MPM list indicator in that state, constructing the MPM list for the block, reading from the bitstream an MPM list index indicating the selected mode on the MPM list and decoding the block in accordance with the selected mode;
the MPM list membership indicator in another state indicating that the selected mode is not a member of the MPM list, and, responsive to the MPM list indicator in that state, reading mode-identification information from the bitstream to enable identification of the selected mode as a member of a mode list comprising all of the plurality of modes and decoding the block in accordance with the selected mode.

41. A signal bearing a bitstream generated by an encoder in accordance with claim 1.

42. A signal bearing a bitstream generated by an encoding method in accordance with claim 15.
